(19) United States
(12) Patent Application Publication
(10) Pub. No.: US 2020/0381782 A1
(43) Pub. Date: Dec. 3, 2020

(54) Dual Voltage Battery Pack

(71) Applicant: An-Tao Anthony Yang, Burnaby (CA)

(72) Inventor: An-Tao Anthony Yang, Burnaby (CA)

(21) Appl. No.: 16/429,072

(22) Filed: Jun. 3, 2019

(51) Int. Cl. H01M 10/42; H02H 7/18; H01M 2/34; B60L 50/64; B60L 58/10

(52) U.S. Cl. CPC H01M 10/425; H02H 7/18; H01M 2/348; B60L 50/64; B60Y 2400/112; H01M 2200/103; H01M 2010/4271; H01M 2220/20; B60Y 2200/91; B60L 58/10

(57) ABSTRACT

The present invention provides a dual voltage battery pack for electric vehicle, which will maintain low-voltage battery power after disconnecting the DC-link from the high-voltage battery source.

### FIELD OF INVENTION

The present invention provides a dual voltage battery pack for electric vehicles, in particular a dual voltage battery pack for electric buses.

### BACKGROUND

Electric vehicle contains two onboard battery systems: the high voltage battery and the low voltage battery. The high voltage battery provides energy for vehicle traction, and the low voltage battery, same as gasoline vehicles, provides energy for the digital control circuits, pumps, wipers, fans, display and accessory features. Unlike the gasoline vehicles, the low voltage battery onboard an electric vehicle is charged by a voltage converter instead of an alternator.

The charging current of an alternator is dependent on the engine speed; When the engine is at idle, the charging rate is very limited. On the other hand, a voltage converter is controlled via constant current/constant voltage (CC/CV) logic, which will always provide a maximum current output when the voltage is lower than maximum. Since the safety regulation prohibits high voltage being present outside of the battery enclosure when the vehicle is turned off, the voltage converter will not be functional when the vehicle is turned off. There are various components, such as security camera, vehicle locator and keyless entry system, on a vehicle that consumes electrical power even after the vehicle has been turned off. These consumptions are often referred to as the standby power consumptions. The standby power consumptions would not affect the low voltage if the vehicle wasn't turned off for a prolonged period of time. However, if the vehicle was parked overnight, or even worse over weekend, the low voltage battery would be drained to a lower state of charge (SOC). As a result, when the vehicle is again turned on, the voltage converter will be providing maximum current output due to the lower voltage level. Unless a battery capable of fast charge is used, this high rate of charging would shorten the battery life. In actual electric buses currently in operation, the low voltage battery needs to be replaced every six months.

### Problems to be Solved

The primary objective of the present invention is to provide a dual voltage battery pack which the low voltage battery life would not be affected by the standby power consumption.

The secondary objective of the present invention is to provide a dual voltage battery pack which no high voltage is present outside of the battery enclosure when the vehicle has been turned off.

### SUMMARY OF INVENTION

Provided in the preferred embodiment is a dual voltage battery pack wherein the low voltage battery is constantly being charged even when the vehicle is turned off. The dual voltage battery comprises: an isolation enclosure, a high voltage battery, a lower voltage battery, a voltage converter, a manual service disconnect, a contactor, a fuse, a soft-start resister, a high voltage positive terminal, a high voltage negative terminal, a low voltage positive terminal and a low voltage negative terminal.

### Advantage of Invention

According to the present invention, the life spam of the low voltage battery can be ensured.

### DESCRIPTION OF THE DRAWINGS

FIG. 1 is the schematic of the prior art.

FIG. 2 is the schematic of the preferred embodiment.

### DESCRIPTION

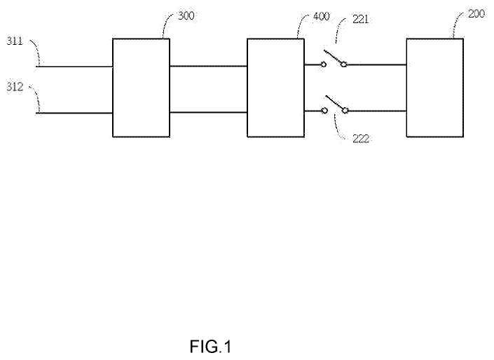

Referring to FIG. 1, the electrical layout on the conventional electric vehicle includes: high voltage battery 200, high voltage positive contactor 221, high voltage negative contactor 222, low voltage battery 300, low voltage positive terminal 311, low voltage negative terminal 312 and voltage converter 400.

The high voltage battery 200 having a positive terminal connected to the high voltage positive contactor 221 and a negative terminal connected to the high voltage negative contactor 222. The voltage converter 400 has an input connected to the high voltage positive contactor 221 and the high voltage negative contactor 222, and an output connected to the low voltage battery 300. The low voltage battery 300 also have a low voltage positive terminal 311 and a low voltage negative terminal 312 which provides low voltage power to the vehicle. The high voltage battery 200, the high voltage positive contactor 221 and the high voltage negative contactor 222 are located inside an insulated enclosure (not shown).

When the vehicle is turned off, the high voltage positive contactor 221 and the high voltage negative contactor 222 are deenergized, which disconnects the voltage converter 400 from the high voltage battery 200. Since the low voltage battery 300 is still connected to the vehicle via the low voltage positive terminal 311 and the low voltage negative terminal 312, the low voltage battery 300 is still being drained by the standby power consumption. When the vehicle is turned on, due to the reason that the low voltage battery 300 is already at a lower voltage level, the voltage converter 400 will charge the low voltage battery 300 with the maximum output current.

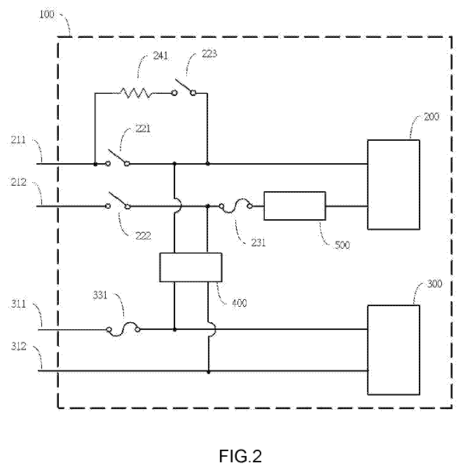

Referring to FIG. 2, a dual voltage battery pack according to the preferred embodiment includes: an isolation enclosure 100, a high voltage positive terminal 211, a high voltage negative terminal 212, a low voltage positive terminal 311, a low voltage negative terminal 312, a high voltage battery 200, a high voltage positive contactor 221, a high voltage negative contactor 222, a soft-start contactor 223, a first fuse 231, a soft-start resistor 241, a low voltage battery 300, a second fuse 331, a voltage converter 400 and a manual service disconnect 500.

The isolation enclosure 100 is preferably constructed with a metallic material having insulation material or air gap to provide a voltage barrier and have openings provided for the installation of high voltage positive terminal 211, high voltage negative terminal 212, low voltage positive terminal 311, low voltage negative terminal 312 and manual service disconnect 500, which are installed through the opening provided.

The high voltage battery 200, the high voltage positive contactor 221, the high voltage negative contactor 222, the soft-start contactor 223, the first fuse 231, the soft-start resistor 241, the low voltage battery 300, the second fuse 331 and the voltage converter 400 resides within the isolation enclosure 100. The positive end of the high voltage battery 200 connects to the high voltage positive contactor 221, the soft-start contactor 241 and the positive input of the voltage converter 400; the soft-start contactor 223 connects to the soft-start resistor 241; the soft-start resistor 241 and the high voltage positive contactor 221 connect to the high voltage positive terminal 211. The negative end of the high voltage battery 200 connects to the manual service disconnect 500, the manual service disconnect 500 connects to the first fuse 231, and the first fuse 231 connects to the high voltage negative contactor 222 and the negative input of the voltage converter 400, and the high voltage negative contactor 222 connects to the high voltage negative terminal 212. The positive output of the voltage converter 400 connects to the positive end of the low voltage battery 300 and the second fuse 331, the second fuse connects to the low voltage positive terminal 311, and the negative output of the voltage converter 400 connects to the negative end of the low voltage battery 300 and the low voltage negative terminal 312.

The high voltage battery 200 and the low voltage battery 300 include multiple rechargeable battery cells. The manual service disconnect 500 and the first fuse 231 can also be placed in the electrical middle point of the high voltage battery 200. A voltage barrier can also be provided between the high voltage battery 200 and the low voltage battery 300 to ensure proper isolation between the high voltage circuit and the low voltage circuit.

A battery management unit (not shown) is also provided to monitor the status of the high voltage battery 200 and the low voltage battery 300, and to control the voltage converter 400. If the status of charge drops too low in the high voltage battery 200 or a fault has been found in the high voltage battery 200 or the low voltage battery 300, the voltage converter 400 is disabled through communication.

1. A dual voltage battery pack comprising:
an isolation enclosure having multiple openings, a high voltage positive terminal, a high voltage negative terminal, a low voltage positive terminal, a low voltage negative terminal, a high voltage battery, a low voltage battery, a high voltage positive contactor, a high voltage negative contactor, and a voltage converter,
wherein said high voltage positive terminal, said high voltage negative terminal, said low voltage positive terminal and said low voltage negative terminal are mounted through said multiple openings,
wherein said multiple openings are provided on said isolation enclosure,
wherein a positive end of said high voltage battery connects to said high voltage positive contactor and a positive input of said voltage converter,
wherein a negative end of said high voltage battery connects to said high voltage negative contactor and a negative input of said voltage converter,
wherein a positive output of said voltage converter connects to a positive end of said low voltage battery and said low voltage positive terminal,
wherein a negative output of said voltage converter connects to a negative end of said low voltage battery and said low voltage negative terminal,
wherein said high voltage positive terminal connects to said high voltage positive contactor, and wherein said high voltage negative terminal connects to said high voltage negative contactor.

2. The dual voltage battery pack as claimed in claim 1, further comprising: an overcurrent protection means provided (i) between the positive end of said high voltage battery and the high voltage positive terminal or (ii) between the negative end of said high voltage battery and said high voltage negative terminal.

3. The dual voltage battery pack as claimed in claim 1 further comprising: an overcurrent protection means provided between the positive end of said low voltage battery and low voltage positive terminal or between the negative end of said low voltage battery and said low voltage negative terminal.

4. The dual voltage battery pack as claimed in claim 1 further comprising: a battery management unit which instructs said voltage converter to stop operation in case a fault is found in said high voltage battery or in said low voltage battery.

5. The dual voltage battery pack as claimed in claim 1, further comprising: a soft-start means connecting the positive end of said high voltage battery and said high voltage positive terminal.

6. The dual voltage battery pack as claimed in claim 5, wherein said soft-start means is a resistor and a contactor.

7. The dual voltage battery pack as claimed in claim 2, wherein said overcurrent protection means is a fuse.

8. The dual voltage battery pack as claimed in claim 3, wherein said overcurrent protection means is a fuse.

9. The dual voltage battery pack as claimed in claim 1, further comprising a manual service disconnect which connects to said high voltage battery.
The dual voltage battery pack as claimed in claim 1, further comprising a voltage barrier provided between said high voltage battery and said low voltage battery.
